(19) United States
(12) Patent Application Publication
(10) Pub. No.: US 2007/0257462 A1
(43) Pub. Date: Nov. 8, 2007

(54) Die cast stabilizer bar ends

(75) Inventor: Joseph A. Fader, Brighton, MI (US)

Correspondence Address: CARLSON, GASKEY & OLDS, P.C., 400 WEST MAPLE ROAD, SUITE 350, BIRMINGHAM, MI, 48009, US

(73) Assignee: Meritor Suspension Systems Company, US

(21) Appl. No.: 11/415,670

(22) Filed: May 2, 2006

(51) Int. Cl. B60G 21/055; F16F 1/14; B22D 13/00

(52) U.S. Cl. 280/124.107; 267/273; 164/113

(57) ABSTRACT

A method for forming a stabilizer bar includes providing a metal bar having first and second ends, and die casting first and second receptacles over the respective first and second ends.

### BACKGROUND OF THE INVENTION

The present invention relates generally to a vehicle suspension system and, more particularly, to a stabilizer bar for dampening the roll of a vehicle.

Vehicles are commonly equipped with suspension systems having a stabilizer bar that increases roll rigidity and improves steering stability of the vehicle. Typically, the stabilizer bar is a rod-shaped member that extends laterally across the vehicle. The stabilizer bar includes a central section and an arm segment that extends longitudinally at each end of the central section. An end link couples the end of each arm segment to a control arm of the suspension system.

Typically, a connection feature is used to secure the arm segments to the end links. One type of connection feature includes a ball stud and socket that are commonly manufactured as separate units from the stabilizer bar. The ball stud is secured with a fastener, such as a bolt, through an eye of a mounting portion of the arm segment. The socket is secured to a portion of the end link and receives the ball stud to secure the arm segment to the end link.

There are several disadvantages with such an arrangement. For one, the fasteners can interfere with movement of the end link. Further, the mounting portions and eyes of the arm segments are typically formed in a forging process and secondarily forged or machined to meet dimensional requirements. The secondary forming process adds complexity and expense to the manufacturing process. Additionally, because the ball studs are typically manufactured independently and are fastened to the stabilizer bar, multiple machine operations are necessary and substantial weight is added to the suspension system.

Accordingly, there is a need for a simplified stabilizer bar that can be manufactured economically. This invention addresses those needs and provides enhanced capabilities while avoiding the shortcomings and drawbacks of the prior art.

### SUMMARY OF THE INVENTION

One example method for forming a stabilizer bar includes the steps of providing a metal bar having first and second ends, and die casting first and second receptacles over the respective first and second ends.

One example stabilizer bar for use in a vehicle suspension system includes a metal bar having first and second ends, and first and second die cast receptacles that are respectively formed over the first and second ends.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows.

FIG. 1 illustrates an example vehicle suspension system.

FIG. 2 illustrates one example method for manufacturing a stabilizer bar within the vehicle suspension system.

FIG. 3 illustrates an example cross-sectional shape of a stabilizer bar.

FIG. 4 illustrates an example stabilizer bar with a roughened surface to promote bonding with a receptacle.

FIG. 5 illustrates one example receptacle having an opening for securing a link.

FIG. 6 illustrates the receptacle of FIG. 5 assembled with a ball stud.

FIG. 7 illustrates an example receptacle in the shape of a ball.

FIG. 8 illustrates an example receptacle in the shape of a socket.

### DETAILED DESCRIPTION OF THE PREFERRED EMBODIMENT

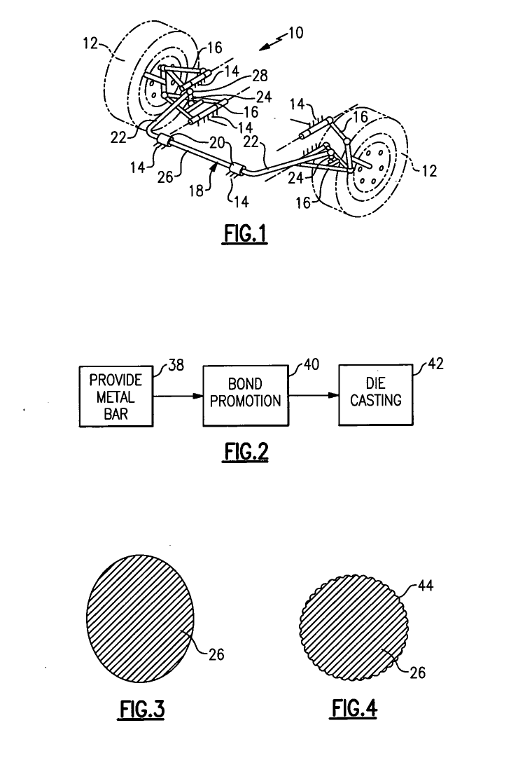

FIG. 1 illustrates selected portions of an example vehicle suspension system 10. In this example, a double transverse link suspension system is illustrated wherein two vehicle wheels 12 are each articulatably connected to a vehicle chassis (schematically illustrated at 14) by transverse links 16. A stabilizer bar 18 is supported at a mounting bracket 20 by the vehicle chassis 14 in a conventional manner. The stabilizer bar 18 includes two arms 22 extending in a generally longitudinal direction relative to the vehicle. The arms 22 are articulatably joined to lower transverse links 16 on each side by an end link 24. In this example, the stabilizer bar 18 includes a metal bar 26. A receptacle 28 is die cast onto each end of the metal bar 26 for connection with the end link 24. In this example, the receptacle 28 and arm 22 are integrally die cast onto the metal bar 26.

Referring to FIG. 2, the stabilizer bar 18 of this example is manufactured in several steps. The metal bar 26 is provided at step 38, such as by hot forming in a known manner. Optionally, a bond promotion step 40 is performed to promote bonding between the die cast receptacle 28 and the metal bar 26. In one example, the ends of the metal bar 26 are formed with an elliptical cross-section (FIG. 3) during hot forming of the metal bar 26. The elliptical cross-section provides the advantage of rotationally locking the metal bar 26 relative to the receptacles 28. Alternatively, or in addition to forming the elliptical shape, the ends of the metal bar 26 are roughened to form a rough surface 44 (FIG. 4). Shot-peening, abrasion, or other known methods may be used to produce the roughened surface 44. The rough surface 44 provides mechanical interlocking between the metal bar 26 and the receptacles 28.

Referring again to FIG. 2, the receptacles 28 are die cast over the ends of the metal bar 26 in a die casting step 42. Die casting the receptacles 28 provides the benefit of achieving relatively tight dimensional tolerances for the receptacles 28 without having to conduct secondary forming processes, such as forging, grinding, etc.

In one example, the metal bar 26 is manufactured from spring steel and the receptacle 28 is also made of steel, but not necessarily spring steel. In one example, using similar materials for the metal bar 26 and the receptacle 28 promotes bonding therebetween because the similar materials form a strong bond. However, in another example, the receptacles 28 and metal bar 26 are made of dissimilar metals. In one example, the receptacles 28 are made of a non-ferrous metal, such as a zinc alloy, an aluminum alloy, or other non-ferrous material. These materials provide the advantage of lighter weight compared to steel.

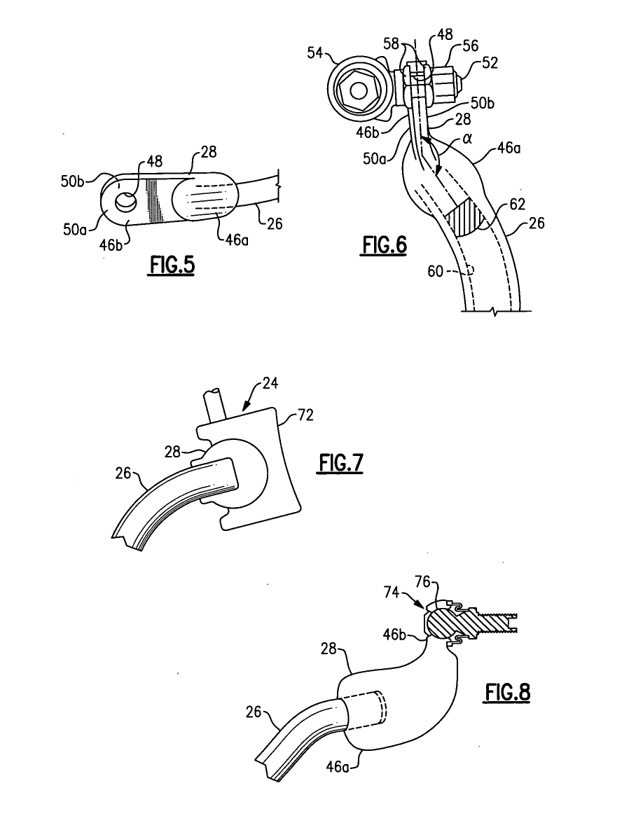

FIG. 5 illustrates one example receptacle 28 that has been die cast over the ends of the metal bar 26. In this example, the receptacle 28 includes a base section 46a die cast directly over the end of the metal bar 26, and a flat end section 46b that extends from the base section 46a. The end section 46b includes an opening 48 that extends between two surfaces 50a and 50b.

FIG. 6 illustrates a modified version of the receptacle 28 shown in FIG. 5, in an assembled arrangement. In this example, a fastener 52 extends through the opening 48 to secure a ball stud 54 to the receptacle 28. The fastener 52 is secured to the receptacle 28 with a nut 56 and a pair of washers 58.

In the illustrated example, the end section 46b forms an angle α with the base section 46a. The angle α, other desired angles, curvatures or the like, can be pre-designed into the receptacle 28. This allows bends or curves near the ends of the metal bar 26 to be eliminated, thereby eliminating additional steps and expense in forming the metal bar 26.

In the illustrated example, die casting the receptacle 28 over the ends of the metal bar 26 provides the benefit of forming the surfaces 50a and 50b parallel to each other within a desired tolerance. Parallel surfaces 50a and 50b allow uniform distribution of the stress exerted on the receptacle 28 from tightening of the nut 56 and washers 58 on the fastener 52. Prior assemblies having receptacles that are, for example, formed by forging are unable to achieve the degree of tolerance that is possible with die casting without utilizing a secondary forming process. Thus, the die cast receptacle 28 provides flatter surfaces 50a and 50b for enhanced stress distribution without the need for a secondary forming process.

The metal bar 26 in the illustrated embodiment is hollow such that a passage 60 extends through the metal bar 26. Before the die casting step 42, a plug 62 is inserted within the passage 60 at each end of the metal bar 26 to prevent molten die cast material from flowing through the passage 60 during formation of the receptacles 28. The plug 62 also provides the benefit of sealing the metal bar 26 (in addition to the receptacles 28) to prevent environmental elements, such as road water, from infiltrating the passage 60 and corroding the metal bar 26 from the inside.

FIG. 7 illustrates an example receptacle 28 in the shape of a ball. The ball has been die cast over the end of the metal bar 26 similar to as described above. In this example, the ball is received into a socket 72 that is part of the end link 24 for securing the stabilizer bar 18 to the lower transverse link 16.

FIG. 8 illustrates an example die cast receptacle 28 wherein the end section 46b includes a socket 74 that extends from the base section 46a. In this example, the socket 74 receives a ball 76, which is part of the end link 24, to secure the stabilizer bar 18 to the lower transverse link 16.

The disclosed examples illustrate receptacles 28 that are die cast over the ends of the metal bar 26. Die casting the receptacles 28 provides the benefit of achieving dimensional tolerances that are difficult or impossible to achieve with previously used methods, such as forging. Thus, with die casting, secondary machining operations may be eliminated in many cases. Furthermore, die casting provides a stabilizer bar 18 having integral receptacles 28. This eliminates the need for fasteners or the like in some examples, which reduces cost and the number of parts in the assembly.

Although a preferred embodiment of this invention has been disclosed, a worker of ordinary skill in this art would recognize that certain modifications would come within the scope of this invention. For that reason, the following claims should be studied to determine the true scope and content of this invention.

We claim:

1. A method for forming a stabilizer bar, the method comprising:
(a) providing a metal bar having first and second ends; and
(b) die casting first and second receptacles over the respective first and second ends.

2. The method as recited in claim 1, wherein step (b) includes forming a mechanical bond between the first and second receptacles and the respective first and second ends.

3. The method as recited in claim 2, wherein step (b) includes forming the first and second ends with a non-circular cross-sectional shape to form the mechanical bond.

4. The method as recited in claim 2, wherein step (b) includes roughening a surface of the first and second ends to form the mechanical bond.

5. The method as recited in claim 1, wherein step (b) includes forming a socket within each of the first and second receptacles.

6. The method as recited in claim 1, wherein step (b) includes forming an opening through each of the first and second receptacles.

7. The method as recited in claim 1, wherein step (b) includes die casting the first and second receptacles with respective first and second flat sections.

8. A stabilizer bar produced according to the method recited in claim 1.

9. A stabilizer bar for use in a vehicle suspension system, comprising:
a metal bar having first and second ends; and
first and second die cast receptacles respectively formed over said first and second ends.

10. The stabilizer bar as recited in claim 9, wherein said metal bar and said first and second receptacles comprise a steel material.

11. The stabilizer bar as recited in claim 9, wherein said first and second receptacles each include a ball.

12. The stabilizer bar as recited in claim 9, wherein said first and second receptacles each include an end section that extends from a base section.

13. The stabilizer bar as recited in claim 12, wherein said end sections include substantially flat and substantially parallel opposing surfaces.

14. The stabilizer bar as recited in claim 12, wherein said end sections each include an opening.

15. The stabilizer bar as recited in claim 12, wherein said end sections each include a socket.

16. The stabilizer bar as recited in claim 12, wherein said end section forms a non-parallel angle with said base section.
